(19) United States
(12) Patent Application Publication
(10) Pub. No.: US 2026/0249792 A1
(43) Pub. Date: Aug. 27, 2026

(54) SILENCER UNIT FOR A UTILITY VEHICLE

(71) Applicant: Knorr-Bremse Systeme für Nutzfahrzeuge GmbH, Munich (DE)

(72) Inventors: Karsten Schnittger, Munich (DE); Victor Javier Munoz Lou, Munich (DE)

(21) Appl. No.: 18/728,113

(22) PCT Filed: Dec. 27, 2022
(86) PCT No.: PCT/EP2022/087922

§ 371 Date: Jul. 11, 2024

(30) Foreign Application Priority Data
Jan. 17, 2022 (DE) 10 2022 101 009.0

(51) Int. Cl. B60R 13/08; B60T 17/00; G10K 11/16

(52) U.S. Cl. CPC B60R 13/08; B60T 17/00; G10K 11/161

(57) ABSTRACT

A silencer unit for a pneumatic brake system of a utility vehicle, the silencer unit comprising an interface for connection to the pneumatic brake system of a utility vehicle, an air inlet, and an air outlet, wherein the silencer unit is oriented non-vertically downwards towards the ground when installed and connected to the pneumatic brake system, and a spray protection element is connected to the silencer unit at least one of around and on the air outlet.

### BACKGROUND AND SUMMARY

The present invention relates to a silencer unit for a utility vehicle.

Utility vehicles generally have pneumatic braking systems. As a rule, the elements of these braking systems are also provided with compressed air outlets, via which compressed air can be released from the system into the atmosphere.

This outflow duct is usually aligned so as to be oriented vertically downwards. When installing the device in the vehicle, a tolerance of +/−30° from the centerline of the device to the vertical axis is often accepted, so that the outlet duct can also have this position.

Silencers are usually used to reduce the volume of the occurring venting noise.

In this context, the centerline of the silencer is parallel to the axis of the outflow duct of the device.

The silencer has a medium for noise reduction, in particular a coiled knitted fabric.

Compressed air can be introduced on a first side of the medium for noise reduction via the interface to the device of the truck's braking system.

The compressed air can exit from the opposite, second side or laterally from the medium for noise reduction. The compressed air therefore flows downwards and radially to the side.

Normally, no spray protection means is provided for the silencer and the air can flow into the free space around the silencer.

When cleaning the device from below with a high-pressure cleaner, water can enter the outflow duct of the truck's braking system device from the outside in a straight line through the medium for noise reduction. One relies on the fact that this water will flow back downwards again through the silencer by gravity.

However, moisture or water in the silencer is particularly problematic at cold outside temperatures because the silencer can then become clogged with ice and may freeze. This can make it difficult or even completely impossible for air to flow out through the silencer. However, this restricts the operability of the air pressure conditioning of the pneumatic brake system of the utility vehicle and can lead to failure and forced maintenance of the brake system.

Silencer units for utility vehicles are already known from the prior art.

For example, DE 10 2013 016 084 A1 discloses a silencer for the ventilation of a pneumatic system, which has a control device housing with a housing base, the housing base comprising a central duct connected to a main exhaust air line of the pneumatic system and an adjacent chamber connected to a control exhaust air line, and comprising a housing cover which is provided with outlet openings and is removably connected to the housing base. The outflow direction is vertically downwards toward the ground (in relation to the installed, operational state).

Furthermore, EP 2 303 659 B1 discloses a noise damper for compressed air systems of vehicles, which has a housing and a damping means, wherein the housing has an air inlet and an air outlet, and the damping means is arranged inside the housing so that the air flows from the air inlet to the air outlet through the damping means and noise damping is achieved in this way. The outflow direction is again vertically downwards toward the ground (in relation to the installed, operational state).

EP 3 400 154 B1 discloses a noise damper for a compressed air system of a utility vehicle comprising a pressure relief valve that operates in a non-destructive manner. The outflow direction is vertically downwards toward the ground (in relation to the installed, operational state).

Moreover, WO 2006/010400 A1 relates to a noise damper for compressed air systems, which comprises a tubular housing part with an air inlet and with insulating material inserted. The insulating material is formed here in particular by a knitted roll. The supplied air should flow in tangentially to the insulating material or to the knitted roll and then be radially deflected within the housing part and flow out axially from one end of the tubular housing part.

It is therefore the object of the present invention to further develop a silencer unit for a utility vehicle of the type referred to above in an advantageous manner, in particular in such a way that any penetration of liquids and/or moisture into the silencer unit can be prevented or significantly reduced.

According to the invention, this object is achieved by a silencer unit for a utility vehicle comprising the features of claim 1. Accordingly, provision is made that a silencer unit for a pneumatic system of a utility vehicle is provided, wherein the silencer unit has at least one interface for connection to the pneumatic system, in particular to an outflow duct of the pneumatic system, the silencer unit has at least one air inlet and at least one air outlet, when the silencer unit is installed and connected to the pneumatic system, the air outlet is oriented non-vertically downwards toward the ground, and a spray protection element is provided around and/or on the air outlet.

The pneumatic system is in particular a pneumatic conditioning system of a utility vehicle, in particular a pneumatic brake system of a utility vehicle.

The invention is based on the fundamental idea that the air flowing through and out of the silencer unit should not be discharged vertically (in relation to the installed, operational state) toward the ground. In addition, the spray protection element is to ensure that little or no water can penetrate the silencer unit. The silencer unit has an interface to a device of the truck's brake system. The device of the truck's brake system, e.g. a part of the pneumatic brake system, has an outflow duct by means of which pressurized air can be introduced into the silencer unit. However, this outflow duct is not directed vertically downwards, as is common today, but has a different orientation, in particular a horizontal orientation. Compressed air can be introduced via the interface to the device of the truck's brake system on a first side of the medium for noise reduction. The compressed air can exit from the opposite, second side or laterally from the medium for noise reduction. The medium for noise reduction may be enclosed by its own housing or integrated into a housing structure of the device of the truck's brake system. A spray protection means is fitted above the air outlet areas of the medium for noise reduction at a distance from it that allows the pressurized air to flow out easily. The spray protection means is designed such that it opens up large outflow cross-sections for the pressurized air and at the same time prevents water from outside from entering the outflow duct of the device of truck's brake system in a straight line through the medium for noise reduction. This makes the ingress of water (or other liquids) more difficult or even completely prevents it. The spray protection means may be attached to a housing surrounding the silencer or can be formed by a surface of another component which is located at a suitable distance from the air outlet areas of the medium for noise reduction.

In particular, it may be provided that the spray protection element is designed such that a fluid can flow through it. In particular, it may be provided that the fluid flowing out of the silencer unit flows through the spray protection element in the installed state. This ensures that no increased dynamic pressure and resistance is generated by the spray protection element and that the outflow through the spray protection element is of favorable design in terms of fluid dynamics.

It is also possible for the silencer unit to have a perforated wall, in particular wherein the perforated wall has several holes and/or slots and/or circular segment-like openings or similar. An outflow can take place through the perforated wall.

The spray protection element may be formed by the combination of shaping the wall and an outer contour of an adjacent element. In particular, it may be provided that the shaping of the wall is adapted to the outer contour of an adjacent element. This combination of perforated wall and the outer contour of an adjacent element, such as a dryer cartridge, for instance, also provides good spray protection. The adjacent element can be arranged so as to be very close to the wall, for example a few millimeters away, e.g. 5-15 mm away (in relation to the installed, operational state).

It is also conceivable to use a spray protection cover as a spray protection element.

In particular, provision may be made that the spray protection element comprises a stepped cover having outlet openings and/or is formed by a stepped cover having outlet openings. The stepped design allows that several outlet openings can be provided in the cover and at the same time the steps provide better protection against water ingress.

The cover can be used as an attachment for the perforated wall. It is conceivable, for example, to use such a cover if the air outlet of the silencer unit is relatively exposed and not partially covered or shielded by other elements, for example. Such elements may be represented, for example, by frame parts of the utility vehicle or, for example, the dryer cartridge of the pneumatic system.

In addition, it may be provided that the spray protection element is designed and constructed in such a way that it provides a sufficiently large outflow cross-section for the pressurized air and at the same time prevents water from outside from passing in a straight line through the silencer unit and into the outflow duct of the device of the truck's brake system. On the one hand, this ensures that adequate spray water protection is provided. At the same time, it also ensures that the air flowing out of the silencer unit can flow out relatively unhindered.

It is also conceivable that the silencer unit comprises a medium for noise reduction in its interior, in particular the fluid flowing through the silencer unit flowing in particular through the medium. In particular, it is conceivable that the medium could be a knitted fabric. The silencer thus has a medium for noise reduction, in particular a coiled knitted fabric.

It is also possible for the perforated wall to be in direct contact with the medium for noise reduction. This results in a compact design.

Furthermore, the present invention relates to a pneumatic system for a utility vehicle. Accordingly, it is provided that the pneumatic system for a utility vehicle is configured so as to comprise at least one silencer unit as described above.

Moreover, the present invention relates to a utility vehicle. Accordingly, it is provided that the utility vehicle is configured so as to comprise at least one pneumatic system as described above or a silencer unit as described above.

Further details and advantages of the invention will now be explained in more detail with reference to an exemplary embodiment shown in the drawing.

### BRIEF DESCRIPTION OF THE DRAWINGS

In the Figures:

FIG. 1 shows a perspective view of an exemplary embodiment of a pneumatic system according to the invention for a utility vehicle with two exemplary embodiments of silencer units according to the invention;

FIG. 2 shows a sectional view of the silencer units according to FIG. 1 in plan view;

FIG. 3 shows a further sectional view of the silencer units according to FIG. 1 in plan view;

FIG. 4 shows a sectional view of the silencer unit for the trailer; and

FIG. 5 shows a sectional view of the silencer unit for the towing vehicle.

### DETAILED DESCRIPTION OF THE DRAWINGS

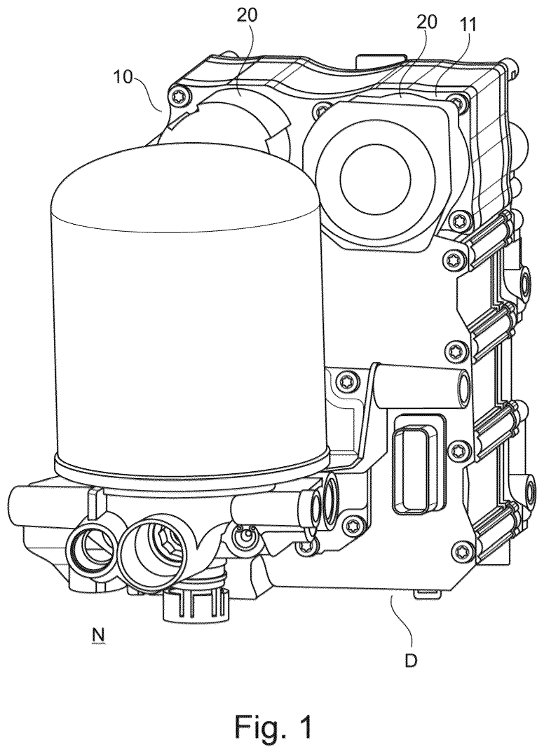

FIG. 1 shows a perspective view of an exemplary embodiment of a pneumatic system D according to the invention for a utility vehicle N with two exemplary embodiments of silencer units 10, 11 according to the invention.

A silencer unit 10 is provided for the brake circuit of the trailer and a silencer unit 11 is provided for the brake circuit of the towing vehicle.

In the example shown, the pneumatic system D for the utility vehicle N is the compressed air brake system or pneumatic brake system of a utility vehicle.

Both the silencer unit 10 and the silencer unit 11 have the following features.

There is an interface 12 to the pneumatic system D.

In the exemplary embodiment shown, the interface 12 is realized by outlet openings 14 on the utility vehicle side or outflow ducts 14 on the utility vehicle side of the pneumatic brake system. The silencer units 10, 11 are positioned in front of the outlet openings and attached to the pneumatic system D in a suitable manner (here with several screws and a mounting plate).

The silencer unit 10 and the silencer unit 11 each have at least one air inlet 16 and at least one air outlet 18.

In both the silencer unit 10 and the silencer unit 11, the air outlet, when the silencer unit 10 or 11 is installed and connected to the pneumatic system D, is oriented non-vertically (in relation to the installed, operational state) downwards toward the ground. Instead, the outflow direction is parallel to the ground, i.e. the outflow direction is horizontal when the ground is horizontal.

In addition, the silencer unit 10 and the silencer unit 11 each have a housing 20.

A medium for noise reduction 22, in this case a wound knitted fabric 22, is arranged in the housing 20.

During operation, the compressed air flows through the knitted fabric before it leaves the silencer.

In addition, the knitted fabric is arranged in the housing 20 in such a way that it at least partially contacts the housing 20 directly.

A spray protection element 24 is provided in front of the silencer unit 10 and silencer unit 11 in each case around and on the air outlet 18, in this case directly in front of the air outlet on the outside of the silencer unit 10 and silencer unit 11.

The spray protection element 24 is designed such that a fluid can flow through it. For the two silencer units, i.e. for both silencer unit 10 and silencer unit 11, it is provided that the fluid flowing out of the silencer unit 10, 11 flows through the spray protection element 24 in the installed state.

In both the silencer unit 10 and the silencer unit 11, the spray protection element 24 is partially formed by providing a perforated wall 26 and a perforated wall 30, respectively.

The perforated wall 26 or 30 is formed in each case by a housing portion of the silencer unit 10 or 11.

In the case of the silencer unit 10 for the trailer, the housing 20 is provided with a large number of round holes or bores 28 in the portion with the perforated wall 26.

In the case of the silencer unit 11 for the towing vehicle, the housing 20 is provided with a large number of circular segment-like openings 32 in the portion with the perforated wall 30.

In both the silencer unit 10 for the trailer and the silencer unit 11 for the towing vehicle, the portions with the perforated wall 26 and 30 are arranged in such a way that they are in direct contact with the knitted fabric 22.

In front of the portion with the perforated wall 30 of the silencer unit 11 for the towing vehicle, a stepped cover 34 with outlet openings is also provided as a component of the spray protection element.

The outlet openings of the stepped cover 34 are only arranged so as to be horizontal (in relation to the installed, operational state, with the utility vehicle standing on level ground).

The cover 34 is designed here as an attachment on the outside of the wall of the housing 20 of the silencer unit 11 for the towing vehicle. It is clipped in place into the openings of the perforated wall 30.

As the perforated wall 26 of the silencer unit 10 is covered by adjacent elements (in this case the dryer cartridge) or components, a cover is not necessary here. The penetration of liquid into the silencer unit 10 is therefore already sufficiently reduced or even prevented by the perforated wall 26 with its comparatively small holes (especially compared to the perforated wall 30 of the silencer unit 11).

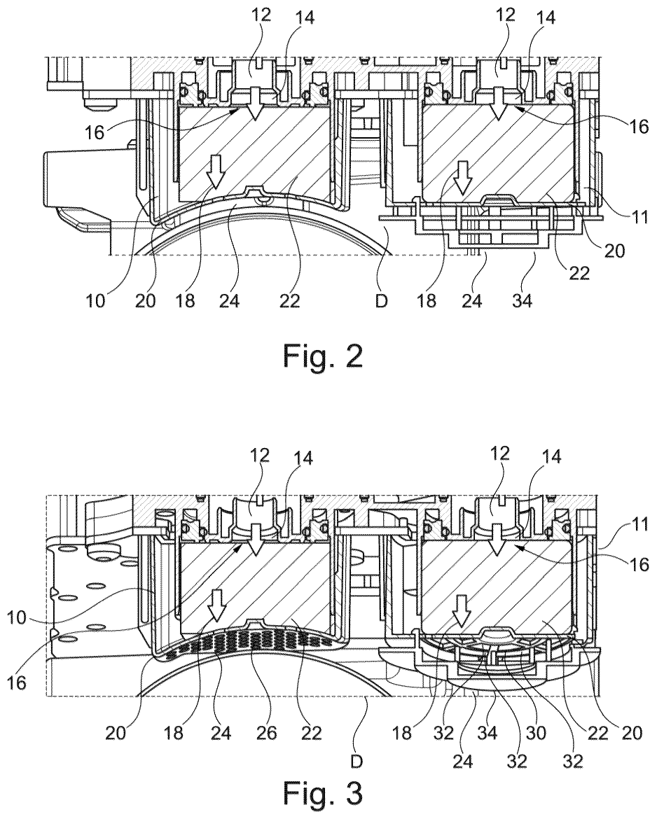

This can be seen in detail in particular in FIG. 2 to FIG. 5.

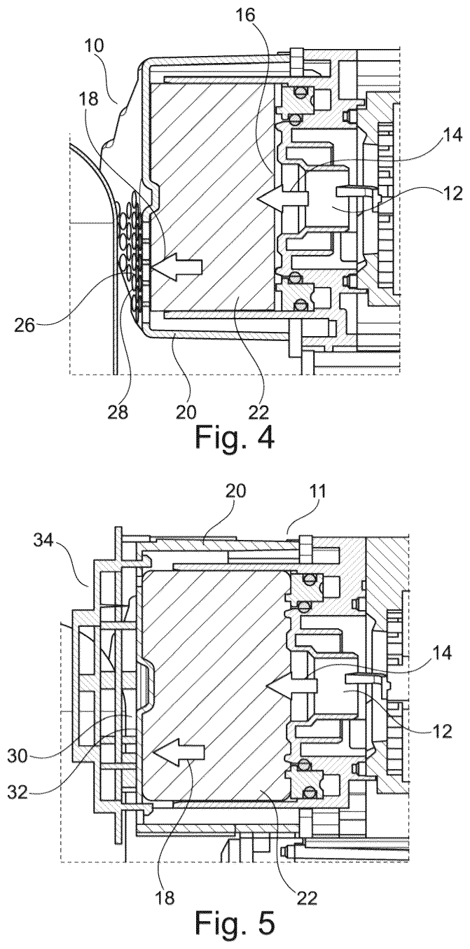

FIG. 2 shows a sectional view of the silencer units according to FIG. 1 in plan view and FIG. 3 shows a further sectional view of the silencer units according to FIG. 1 in plan view. FIG. 4 shows a sectional view of the silencer unit 10 for the trailer. FIG. 5 shows a sectional view of the silencer unit 11 for the towing vehicle unit.

The function of the silencer units 10 and 11 can be described as follows:

If compressed air has to be released to the atmosphere from the compressed air circuit for the trailer, this can be done via silencer unit 10. The compressed air is discharged in horizontal direction and not vertically toward the ground.

This also applies to the compressed air circuit for the towing vehicle, where the compressed air is discharged via silencer unit 11.

Both silencer units 10 and 11 are fitted with spray protection elements 24, which make it more difficult for water to penetrate the silencer units.

Because it is covered by adjacent elements and components, the silencer unit 10 requires less spray protection than the silencer unit 11, which is comparatively unprotected by adjacent elements and components. For this reason, the cover 34 is additionally provided for the silencer unit 11.

In general, it can be said that the spray protection elements are designed and constructed in such a way that they provide a sufficiently large outflow cross-section for the pressurized air and at the same time prevent water from outside from entering the outflow duct of the device of the truck's brake system in a straight line through the silencer unit. On the one hand, this ensures that sufficient spray water protection is provided. At the same time, it also ensures that the air flowing out of the silencer unit can flow out relatively unhindered.

At the same time, water from outside is prevented from entering the outflow duct of the device of the truck's brake system in a straight line through the silencer unit 10 or 11.

### LIST OF REFERENCE NUMERALS

10 silencer unit (trailer)
11 silencer unit (towing vehicle)
12 interface
14 outflow duct (utility vehicle side)
16 air inlet (silencer side)
18 air outlet (silencer side)
20 housing (silencer)
22 medium for noise reduction
24 spray protection element
26 perforated wall (with holes, trailer)
28 holes in perforated wall
30 perforated wall (with circular segment-like openings, towing vehicle)
32 circular segment-like openings
34 cover
N utility vehicle
D pneumatic system

1.-10. (canceled)

11. A silencer unit for a pneumatic brake system of a utility vehicle, the silencer unit comprising:
an interface for connection to the pneumatic brake system of a utility vehicle,
an air inlet, and
an air outlet,
wherein the silencer unit is oriented non-vertically downwards towards the ground when installed and connected to the pneumatic brake system, and a spray protection element is connected to the silencer unit at least one of around and on the air outlet.

12. The silencer until according to claim 11, wherein the spray protection element in the installed state is designed to received fluid flowing from the silencer and the spray protection element has capacity to allow fluid to flow through it.

13. The silencer until according to claim 12, wherein on the air outlet side of the silencer unit, the silencer unit has at least one of a wall, a perforated wall and a perforated wall section having a plurality of at least one of holes, slots and circular segment-like openings.

14. The silencer unit according to claim 13, wherein a shape of a wall of the silencer unit is generally contoured according to an outer contour of an adjacent element.

15. The silencer unit according to claim 13, wherein the spray protection element comprises a stepped cover having at least one outlet opening.

16. The silencer unit according to claim 13, wherein the air outlet of the spray protection element includes a cross-section sized for releasing pressurized air and, at the same time, preventing water ingress from outside the silencer unit from passing through the silencer unit and into an outflow duct of the pneumatic brake system.

17. The silencer until according to claim 13, wherein the silencer unit comprises a noise reduction medium, wherein fluid flowing through the silencer unit flows through the medium.

18. The silencer until according to claim 17, wherein at least one of the perforated wall and the perforated wall section contacts the noise reduction medium.

19. A pneumatic system for a utility vehicle comprising at least one silencer unit for a pneumatic brake system of a utility vehicle, the silencer unit comprising:
an interface for connection to the pneumatic brake system of a utility vehicle,
an air inlet, and
an air outlet,
wherein the silencer unit is oriented non-vertically downwards towards the ground when installed and connected to the pneumatic brake system, and a spray protection element is connected to the silencer unit at least one of around and on the air outlet.

20. A vehicle comprising the pneumatic system according to claim 19.

21. A method for using a silencer unit for a pneumatic brake system of a utility vehicle, the silencer unit comprising:
an interface for connection to the pneumatic brake system of a utility vehicle,
an air inlet, and
an air outlet,
wherein the silencer unit is oriented non-vertically downwards towards the ground when installed and connected to the pneumatic brake system, and a spray protection element is connected to the silencer unit at least one of around and on the air outlet.
